(19) United States
(12) Patent Application Publication
(10) Pub. No.: US 2016/0379547 A1
(43) Pub. Date: Dec. 29, 2016

(54) PORTABLE ELECTRONIC DEVICE EQUIPPED WITH DISPLAY, DISPLAY CONTROL SYSTEM, AND DISPLAY CONTROL METHOD

(71) Applicant: CASIO COMPUTER CO., LTD., Tokyo (JP)

(72) Inventor: Kayo OKADA, Tokyo (JP)

(73) Assignee: CASIO COMPUTER CO., LTD., Tokyo (JP)

(21) Appl. No.: 15/077,728

(22) Filed: Mar. 22, 2016

(30) Foreign Application Priority Data
Jun. 29, 2015 (JP) 2015-129904

(51) Int. Cl. G09G 3/20; G06F 3/14; G06F 1/16; G06F 1/32

(52) U.S. Cl. CPC G09G 3/2096; G06F 1/3234; G06F 3/14; G06F 1/163; G09G 2340/0407

(57) ABSTRACT

A portable electronic device includes: a display unit; an action storage unit configured to store therein an action history of a user; and a control unit configured to control the display unit, wherein the display unit is configured to be capable of displaying a first display state having a low power consumption and a low-definition display content and a second display state having a high power consumption and a high-definition display content relatively with respect to each other, and the control unit has a display control unit configured to control, with reference to the action history of the user, driving of the first display state and the second display state such that the display state is adapted to an action state of the user.

### CROSS-REFERENCE TO RELATED APPLICATION

This application is based upon and claims the benefit of priority under 35 USC 119 of Japanese Patent Application No. 2015-129904 filed on Jun. 29, 2015 the entire disclosure of which, including the description, claims, drawings, and abstract, is incorporated herein by reference in its entirety.

### BACKGROUND OF THE INVENTION

1. Field of the Invention

The present invention relates to a technique for appropriately controlling operation of a display.

2. Description of the Related Art

Wearable or portable electronic devices available in recent years such as sports watches and smartphones include a variety of sensors and various types of data communication functions. Examples of such sensors include acceleration sensors, gyro sensors (angular velocity sensors), and positioning sensors using a global positioning system (GPS). When the electronic devices are carried and used, these sensors and communication functions are set so as to operate at all times, and various types of information obtained by these sensors and communication functions are provided to users at any time via display devices in various display forms. Accordingly, the users can understand their motion states and moving routes easily.

For example, JP-2013-114698-A discloses a technique to select and display some of a plurality of displays in accordance with content to reduce power consumption of an electronic device. According to the technique disclosed in JP-2013-114698-A, a first display used to display a video and a second display having a lower power consumption than the first display are included. A control unit obtains display designating information designating a display to be used to display content, the display designating information being included in a launched application, and outputs the launched application to any of the first display and the second display based on the display designating information. The display as used herein refers to a plurality of displays disposed in a stacking manner.

### SUMMARY OF THE INVENTION

According to an embodiment of the present invention, there is provided an electronic device including: a display unit; an action storage memory configured to store therein an action history of a user; and control unit configured to control the display unit, wherein the display unit is configured to be capable of displaying a first display state and a second display state having a higher power consumption than the first display state, and the control unit controls, based on the action history of the user, the first display state and the second display state such that the display state is adapted to an action state of the user.

According to another embodiment of the present invention, there is provided a display control system including: an electronic device; and server coupled to the electronic device via a network, wherein the electronic device includes: a display unit configured to be capable of displaying a first display state having a low power consumption and a low-definition display content and a second display state having a high power consumption relatively with respect to each other; and a control unit configured to control, based on an action history of a user, driving of the first display state and the second display state such that the display state is adapted to an action state of the user.

According to another embodiment of the present invention, there is provided a display control method including the steps of, by a computer of an electronic device: storing an action history of a user; and controlling, in accordance with the action history, driving of a first display state having a low power consumption and a low-definition display content and a second display state having a high power consumption relatively with respect to each other such that the display state is adapted to an action state of the user.

The present invention has been made in consideration of the above-mentioned circumstances, and an object thereof is to provide a portable electronic device, a display control system, and a display control method capable of appropriately controlling operation of a display in accordance with various types of users or a variety of user actions.

According to an embodiment of the present invention, operation of a display can be appropriately controlled in accordance with various types of users or a variety of user actions.

### BRIEF DESCRIPTION OF THE DRAWINGS

FIG. 1 is a block diagram illustrating a configuration of a portable electronic device according to a first embodiment of the present invention;

FIG. 2 is a diagram illustrating an exemplary configuration of a display unit of FIG. 1 and a periphery thereof;

FIG. 3A is a diagram illustrating an exemplary data structure of an input data table of FIG. 1 indicating a motion state;

FIG. 3B is a diagram illustrating an exemplary data structure of an input data table of FIG. 1 indicating an external environment;

FIG. 4A is a diagram illustrating an exemplary data structure of an action pattern determination table in an action pattern storage unit of FIG. 1;

FIG. 4B is a diagram illustrating an exemplary data structure of an action pattern prediction table in the action pattern storage unit of FIG. 1;

FIG. 5 is a flowchart illustrating basic operation of the portable electronic device according to the first embodiment of the present invention;

FIG. 6 is a flowchart illustrating in detail a part of the operation of FIG. 5;

FIG. 7 is a diagram illustrating a configuration of a display control system according to a second embodiment of the present invention; and

FIG. 8 is a diagram illustrating an operation sequence of the display control system according to the second embodiment of the present invention.

### DETAILED DESCRIPTION OF THE PREFERRED EMBODIMENTS

Hereinafter, embodiments for practicing the present invention (hereinafter referred to as embodiments) will be described in detail with reference to the accompanying drawings. In the subsequent drawings, identical elements are provided with the same numbers or reference signs throughout the entire description of the embodiments.

(Configuration of First Embodiment)

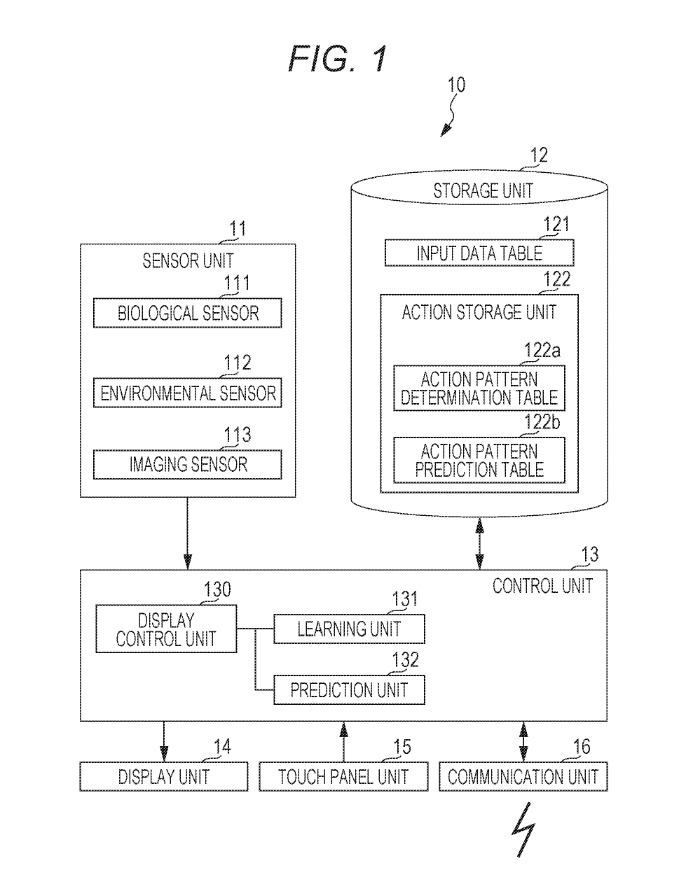

FIG. 1 is a block diagram illustrating a configuration of a portable electronic device according to a first embodiment of the present invention. The portable electronic device 10 according to the first embodiment is assumed to be a wearable electronic device that can be wound around an arm of a user while the user is running or jogging. The portable electronic device 10 therefore includes, as illustrated in FIG. 1, a sensor unit 11, a storage unit 12, a control unit 13, a display unit 14, a touch panel unit 15, and a communication unit 16.

The sensor unit 11 includes a biological sensor 111 and an environmental sensor 112 including a GPS receiver.

The biological sensor 111 includes a plurality of sensors that measures biological information such as a physical condition of the user (e.g., pulse (heart rate), blood pressure, and body temperature). The biological information measured by the biological sensor 111 is stored in a work area of the storage unit 12. The environmental sensor 112 includes a plurality of sensors that measures environmental information such as an environment where the user is located (e.g., temperature, atmospheric pressure, humidity, ultraviolet dose, and noise). The environmental information measured by the environmental sensor 112 is stored in the work area of the storage unit 12.

The environmental sensor 112 includes, in addition to the GPS receiver, a triaxial geomagnetic sensor, a uniaxial acceleration sensor, and a uniaxial gyro or the like. The GPS receiver receives, through an antenna, radio waves transmitted from a plurality of positioning satellites (GPS satellites) to obtain position data including latitude and longitude indicating a current position. The GPS receiver then supplies, to the control unit 13, the obtained position data as position information indicating a place where the user performs an action. The GPS receiver measures a so-called absolute position. By using the triaxial geomagnetic sensor, the uniaxial acceleration sensor, and the uniaxial gyro in addition to the GPS receiver, it is even possible to measure movement of the device in a triaxial direction. A combination of these sensors enables a moving track or a motion log of the user to be accurately traced. The position information measured by the GPS receiver or the like of the environmental sensor 112 is stored in the work area of the storage unit 12 in the same way as the biological information and the environmental information.

The sensor unit 11 may further include an imaging sensor 113 such as a CMOS and a CCD. The user can photograph and record, for example, a face of the user or a surrounding view to use them as an action history. An image recognition technique makes it possible to analyze a facial expression of the user to understand his/her feelings or fatigue degree. Such an image recognition technique can therefore be used as an alternative to the biological sensor 111.

A static random access memory (SRAM), a dynamic random access memory (DRAM) or the like backed up by a battery is implemented in the storage unit 12. Not only a program area that stores therein a display control program according to an embodiment of the present invention but also the work area that stores therein various data generated in a program execution process is assigned to the storage unit 12. Specifically, the data stored in the work area include an input data table 121 and an action storage unit 122. The input data table 121 stores therein a motion state of the user which is estimated from the biological information, the environmental information, and the position information or the like measured by the sensor unit 11. The action storage unit 122 preliminarily stores therein a typically classified action pattern or stores therein an action history of the user by learning a result measured by the sensor unit 11. Data structures of the input data table 121 and the action storage unit 122 (action pattern determination table 122a and action pattern prediction table 122b) will be described later.

The control unit 13 controls the sensor unit 11 coupled thereto according to the display control program stored in the program area of the storage unit 12. In addition, the control unit 13 also controls the display unit 14, the touch panel unit 15, and the communication unit 16, each coupled to the control unit 13 as a peripheral device. The control unit 13 also controls, according to the display control program and with reference to the action storage unit 122, operation of the display unit 14 such that the operation is adapted to an action state of the user (mode control). In this regard, the action state includes an action state (first action state) currently in progress and an action state (second action state) predicted to be a subsequent action state. The control unit 13 therefore controls, with reference to the action storage unit 122, an operation state of the sensor unit 11 such that the operation state is adapted to a current action of the user. The control unit 13 also predicts a subsequent next action of the user with reference to the action storage unit 122 and controls the operation state of the sensor unit 11 such that the operation state is adapted to the predicted next action of the user.

In order to realize the above-mentioned function, the control unit 13 includes, as represented by blocks developed from a structure of the display control program to be executed, a display control unit 130, a learning unit 131, and a prediction unit 132.

The display control unit 130 controls operations of the learning unit 131 and the prediction unit 132. The display control unit 130 also controls, with reference to the action storage unit 122, driving of a display state (first display state) having a low power consumption and a low-definition display content and a display state (second display state) having a high power consumption and a high-definition display content such that the display state is adapted to the action state of the user. As described later, the display unit 14 is configured to be capable of displaying the first display state and the second display state relatively with respect to each other. A detailed hardware configuration for realizing this feature will be described later.

The learning unit 131 performs control so as to learn using the result measured by the sensor unit 11, cause the learning result to be reflected in the typically classified action pattern preliminarily stored in the action storage unit 122, and store such an action pattern as the action history of the user. In other words, the action history is sequentially updated in accordance with the action of the user, and the action state is estimated based on the learning with reference to the updated action history. The prediction unit 132 functions in cooperation with the display control unit 130. Accordingly, the prediction unit 132 predicts, with reference to the action storage unit 122, the next action of the user when the display driving of the display unit 14 is controlled to be adapted to the current action of the user. The prediction unit 132 then controls the driving of the display unit 14 such that the display unit 14 is adapted to the predicted next action of the user.

The display unit 14 is a display monitor including, for example, a liquid crystal device (LCD) and a drive circuit that drives the LCD. The touch panel unit 15 is provided on the display unit 14, and operation is performed by touching a display screen. The communication unit 16 is a wireless communication interface that establishes, for example, a link such as Bluetooth (registered trademark) with an external device (not illustrated) such as a smartphone terminal and a server.

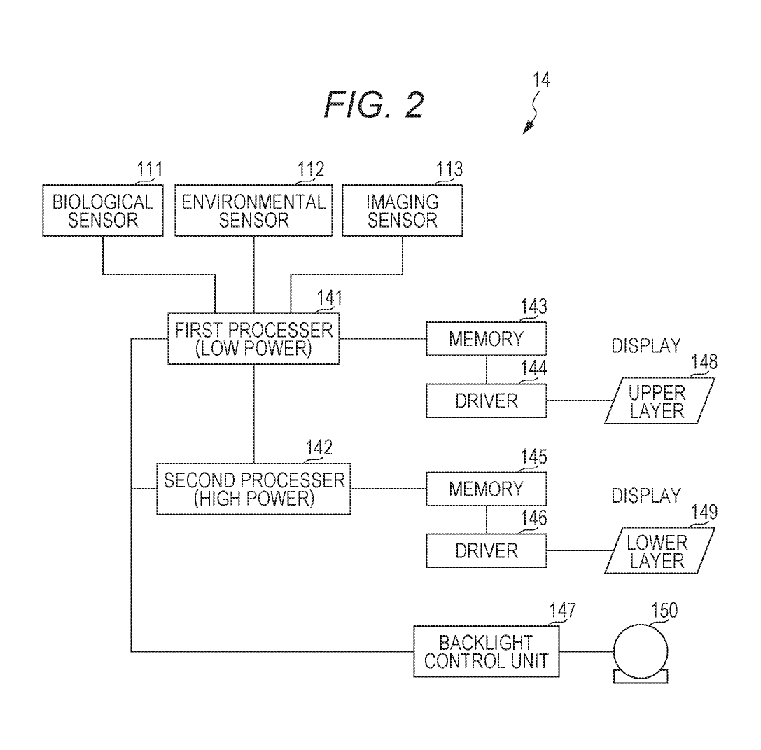

A hardware structure of the display unit 14 and a periphery thereof is illustrated in FIG. 2. According to FIG. 2, the display unit 14 includes a multi-layer display 148, 149. The display 148 (first display) is disposed on an upper layer, and the display 149 (second display) is disposed on a lower layer in a stacking manner. A first processor 141 and a second processor 142 implemented for realizing the function of the display control unit 130 of FIG. 1 operate in cooperation with each other. Accordingly, the multi-layer display 148, 149 is configured to be capable of displaying the display state having a low power consumption and a low-definition display content and the display state having a high power consumption and a high-definition display content relatively with respect to each other.

On the upper layer, a PN layer is disposed as the display 148. A polymer network (PN) liquid crystal or a polymer dispersed liquid crystal has such a property that in a case where an electric potential is applied to the PN liquid crystal locally, polymer materials with which a polymer matrix is filled are aligned in an electric field direction (direction orthogonal to a surface of the liquid crystal) at a part to which the electric potential is applied. At the part where the polymers are aligned, external light penetrates a scattering layer with which the polymer matrix is filled, and is absorbed largely into a non-reflection layer. The part where the polymers are aligned therefore appears black when viewed from the outside. On the other hand, since molecules remain in a scattering arrangement at a part to which no electric potential is applied, such a part strongly reflects external light diffusely and appears white when viewed from the outside. The PN liquid crystal makes use of this phenomenon to have such a property, in particular, as to produce an intense contrast between the local parts in a strong external light environment such as outdoor fine weather, leading to its excellent visibility. Since the PN liquid crystal also has such a property as to maintain the above-mentioned state without the help of any power, one of the main characteristics of the PN liquid crystal is the low power consumption.

The PN liquid crystal further has such a property as to transmit light even from behind the PN liquid crystal. A thin film transistor (TFT) liquid crystal is disposed as the lower-layer display 149 in a stacking manner. When the liquid crystal is irradiated with a backlight light emitting diode (LED) 150 from behind the TFT liquid crystal, the liquid crystal is turned ON to provide a color display. This causes such a phenomenon that a part characterized by diffused reflection does not transmit light from a back color liquid crystal, and only a part characterized by polymer alignment transmits light from the back color liquid crystal. In other words, at the part to which the electric potential is applied, the PN liquid crystal serving as the upper-layer display 148 transmits not only sunlight from all the directions but also light from the back color liquid crystal serving as the lower-layer display 149. As a result, such a property is obtained that the color display emerges from the lower layer, and the PN liquid crystal layer and the TFT color liquid crystal layer appear to overlap each other. In still other words, while the color liquid crystal of the lower-layer display 149 is OFF, the part to which the electric potential is applied absorbs light to be displayed in black. While the backlight LED 150 and the color liquid crystal are ON, the part to which the electric potential is applied becomes transparent to make the color display visible.

For this purpose, a CPU having a dual configuration including the first processor 141 and the second processor 142 is implemented in such a configuration that the processors operate in cooperation with each other. In other words, the relatively low-powered processor 141 (first processor) that controls the display 148 having an extremely low power consumption disposed on the upper layer and the high-performance processor 142 (second processor) that controls the display 149 having a relatively high power consumption but capable of providing the color display disposed on the lower layer are used in combination. In terms of the design, however, the two identical processors may be implemented to be used for the different purposes. Furthermore, the two processors are not necessarily physically required. A dual processor including two processor cores within a single package may also be employed.

A memory 143 coupled to the first processor 141 is a video RAM (VRAM) in which display data are drawn and read in synchronization with a display timing of the upper-layer display 148. A driver 144 is a display drive circuit that serves for this purpose. A memory 145 coupled to the second processor 142 is a VRAM in which display data are drawn and read in synchronization with a display timing of the display 149. A driver 146 is a display drive circuit that serves for this purpose. The backlight LED 150 is configured to be controlled by a backlight control unit 147, and the backlight control unit 147 is configured to be controlled by the first processor 141 and the second processor 142. In other words, such a configuration allows both of the first processor 141 and the second processor 142 to control turning-on and turning-off of the backlight LED 150 as the first processor 141 and the second processor 142 control the display unit 14.

The display control unit 130 including the above-mentioned hardware structure has, as display modes, a “first mode”, a “second mode”, a “third mode”, and a “fourth mode”. The “first mode” provides the display state having a low power consumption and a low-definition display content. The “second mode” provides the display state having a high power consumption and a high-definition display content. The “third mode” combines and displays both of the display state having a low power consumption and a low-definition display content and the display state having a high power consumption and a high-definition display content. The “fourth mode” suspends both of the display state having a low power consumption and a low-definition display content and the display state having a high power consumption and a high-definition display content.

In a case where the operation for the touch panel unit 15 or the like has not been detected for a predetermined period of time or more in the “second mode” and the “third mode”, the display control unit 130 also performs control so as to shift the display to the “fourth mode”. In addition, the display control unit 130 causes the first processor 141 and the second processor 142, each being independent of the other, to operate in cooperation with each other to share information such that, in the “third mode”, the first display state and the second display state are displayed in synchronization with each other. The upper-layer display 148 and the lower-layer display 149 can be displayed at the same time to be displayed to overlap each other. In this case, the display control unit 130 needs to provide the synchronized displays in consideration of the appearance.

When a wearable wristwatch terminal is used as the display unit 140, for example, it is not necessary to always provide the complete display states. In an extreme case, the display states only need to be provided in such a manner that the “first display state” having an extremely low power consumption is provided at all times, and switched to the high-definition “second display state” only during a period of time when the user is looking at the display unit 14. Possible triggers for causing the display control unit 130 to recognize, as an event, that the user is looking at the display unit 14 include, for example, “button depression”, “touch on the touch panel”, “posture of the user automatically detected by the gyro and the acceleration sensor”, “gesture and specific shock detected by the acceleration sensor”, and “reaction in response to a voice command”.

Once the display control unit 130 detects any of the above-mentioned events, the first processor 141 instructs the second processor 142 to be activated. At the same time, the first processor 141 causes the memory 143 and the driver 144 to stop the communication, and turns the upper-layer display 148 (PN liquid crystal) to an “OFF: transmission” state. The second processor 142 instructed to be activated then starts driving the memory 145 and the driver 146 to start providing the display of the lower-layer display 149 (TFT liquid crystal). The second processor 142 also drives the backlight control unit 147 if necessary to turn the backlight LED 150 on. Subsequently, a drawing update process for the memory 145 is executed. The backlight LED 150 is appropriately turned on and turned off in accordance with the above-mentioned first to fourth display modes. Alternatively, only the backlight LED 150 can be turned off in order to reduce the power consumption. In the first mode, the upper-layer display 148 functions as a transmissive display while the backlight LED 150 is on, and functions as a reflective display while the backlight LED 150 is off. In the first to third modes, it is possible to further reduce the power consumption by turning the backlight LED 150 off before suspending the display.

In such a state, operation is performed such that the bright high-definition color display of the lower-layer display 149 can be observed through the transmissive upper-layer display 148. In terms of suppressing the power consumption, it is preferable that the display mode is shifted to the “fourth mode”, namely the suspension state. Therefore, in a case where the touch panel unit 15 has not been operated for a certain period of time, a timeout is detected, whereby the display mode can be returned to the suspension state.

The display unit 14 is not limited to the multi-layer display, but may include a single-layer display such as a memory-in-pixel (MIP) liquid crystal. The MIP liquid crystal is a type of memory liquid crystal having memories in pixels constituting a screen. Generally, the MIP liquid crystal forms a 1-bit static RAM and an AC-driven drive circuit within a pixel of a liquid crystal display by combining TFTs made of thin films.

Once data are written to the static RAM, the static RAM keeps storing the data unless the power is turned off. Although the static RAM is more complicated than the DRAM in terms of the circuit structure, it is not necessary to make a current flow through the static RAM at regular intervals to maintain the stored contents. The static RAM is therefore effective in saving power as compared with the DRAM. In comparison with a general TFT liquid crystal, although the static RAM has a complicated circuit structure within the pixel, and it is necessary to make a certain amount of current flow through the static RAM at every time when the display is updated, the power consumption can be significantly suppressed.

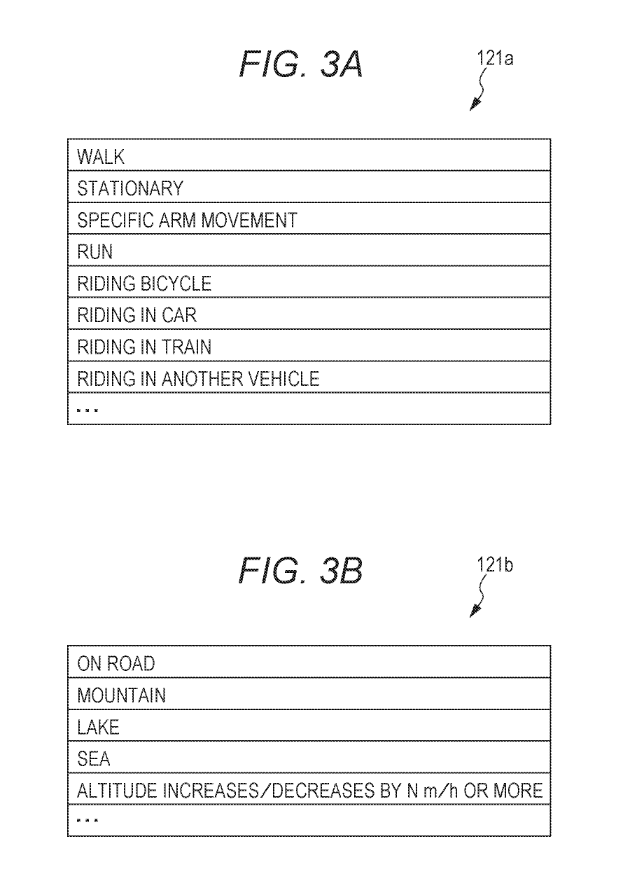

An exemplary data structure of the input data table 121a and an exemplary data structure of the input data table 121b are illustrated in FIGS. 3A and 3B, respectively. The motion state of the user determined based on, for example, the biological information obtained by the biological sensor 111 and the motion log obtained by the environmental sensor 112 is set in the input data table 121a. The input data table 121b is set based on, for example, the external environment obtained by the environmental sensor 112.

According to the input data table 121a of FIG. 3A, the motion state of the user such as “walk” or “stationary” can be determined from, for example, the biological information such as the heart rate and the pulse obtained by the biological sensor 111, and the motion state of the user can be determined from, for example, a movement log such as a movement of a specific arm obtained by the environmental sensor 112. By keeping the environmental information obtained by the environmental sensor 112 or a GPS track and map data, an altitude or other geographic attributes related to specific position information can be found out.

For example, it can be determined that the user is currently on a road, or in a mountain, a lake, a sea or the like. It can further be determined that, for example, the user is in an altitude of n m or higher on a road/in a building/near Mount X/on Lake Y. Such information is set in the input data table 121b of the storage unit 12 under the control of the control unit 13. The data set in the input data table 121b are exemplified in FIG. 3B.

Data provided by Geospatial Information Authority of Japan are used as the data about the altitude. Details of the data about the altitude are disclosed in <Internet URL> “http://www.gsi.go.jp/johofukyu/hyoko_system.html”. Open source map data such as “Open Street Map” enable a building, a road, or a natural object to be tagged in detail with respect to a place or an area. By using the map data, geographic attributes of a certain place can be found out. This feature is disclosed in <Internet URL> “http://wiki.openstreetmap.org/wiki/JA:Map_Features”.

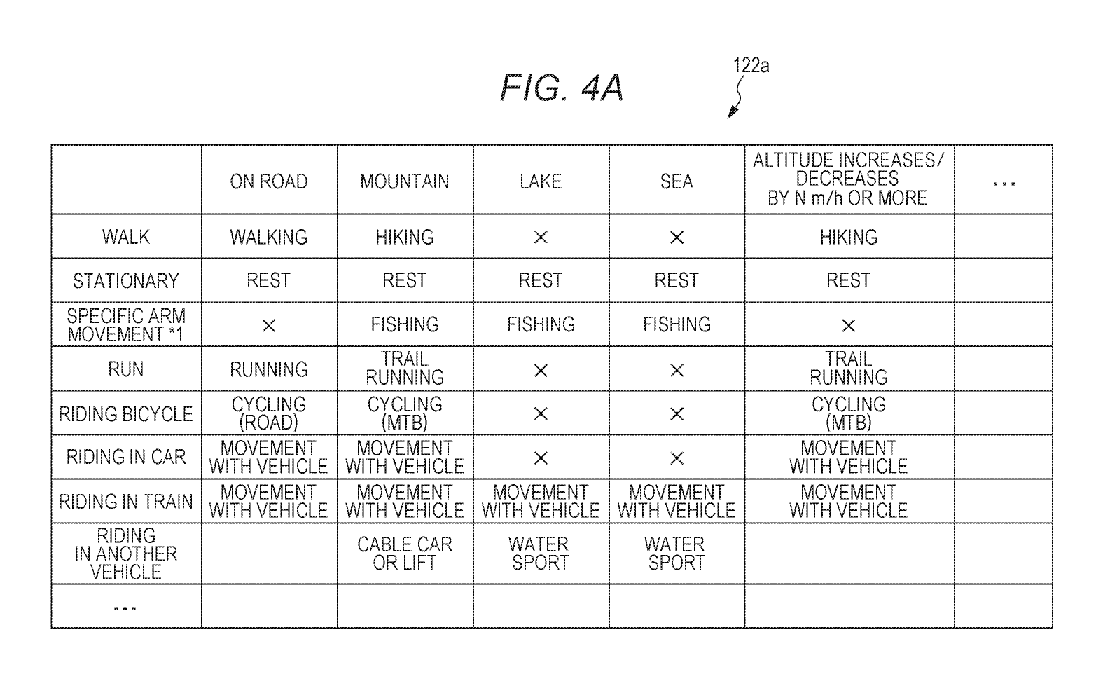

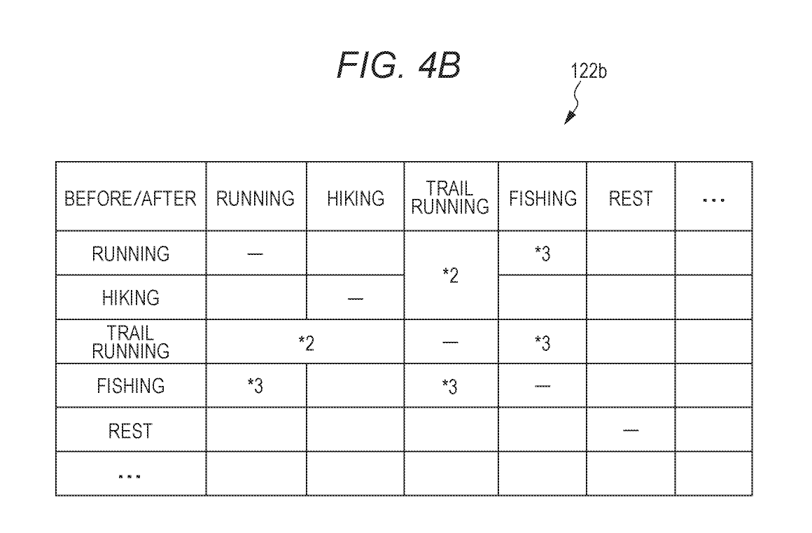

An exemplary data structure of the action pattern determination table 122a stored in the action storage unit 122 and an exemplary data structure of the action pattern prediction table 122b stored in the same action storage unit 122 are illustrated in FIGS. 4A and 4B, respectively.

The action pattern determination table 122a is a table that is used to determine the current action state of the user according to the motion state and the external environment stored in the input data tables 121a, 121b. The action pattern prediction table 122b is a table that is used to predict the next action of the user subsequent to the determined action state and to determine the predicted next action state of the user. Both of the action states are determined or predicted according to a matrix of the motion state (input data table 121a) and the external environment (input data table 121b) set in the input data table 121.

For the determination of the action state, known examples include “Detected Activity API” of Android distributed through smartphones or the like and “Automatic Activity Recognition” that is a Web API and provided by Invensense, Inc.

According to the action pattern determination table 122a of FIG. 4A, in a case where the motion state of the input data table 121a is “walk” and the external environment of the input data table 121b is “on road”, the action state of the user is determined to be “walking”. In a case where the motion state is “walk” and the external environment is “mountain” or “altitude increases/decreases by n m/h or more”, the action state of the user is determined to be “hiking”. The determination is performed by the display control unit 130 of the control unit 13. In a case where the motion state of the input data table 121a is “stationary”, the action state of the user is determined to be “rest” in any external environment of the input data table 121b. In a case where the motion state of the input data table 121a is “specific arm movement”, the action state of the user is determined to be “fishing” for each external environment of the input data table 121b, namely “mountain”, “lake”, and “sea”.

In the action pattern determination table 122a illustrated in FIG. 4A, a mark x represents an action pattern that cannot generally occur, and a mark *1 represents a motion from which a movement that is characteristic of the fishing is estimated. Such a movement includes, for example, swinging a rod to throw a lure and pulling the lure regularly.

According to the action pattern prediction table 122b illustrated in FIG. 4B, in a case where the action states of the user before and after the prediction are “running” and “trail running”, the action state of the user is predicted to be “trail running” even if the motion state deviates to some extent as represented by a mark *2. In a case where the action states before and after the prediction are “running” and “fishing”, as represented by a mark *3, the motion state “specific arm movement” used for the determination of “fishing” is excluded, and operation of the gyro of the environmental sensor 112 is completely removed. As a result, these action states are eliminated as unlikely states or assigned an extremely low priority, whereby estimation accuracy is increased or power consumption is suppressed.

(Operation of First Embodiment)

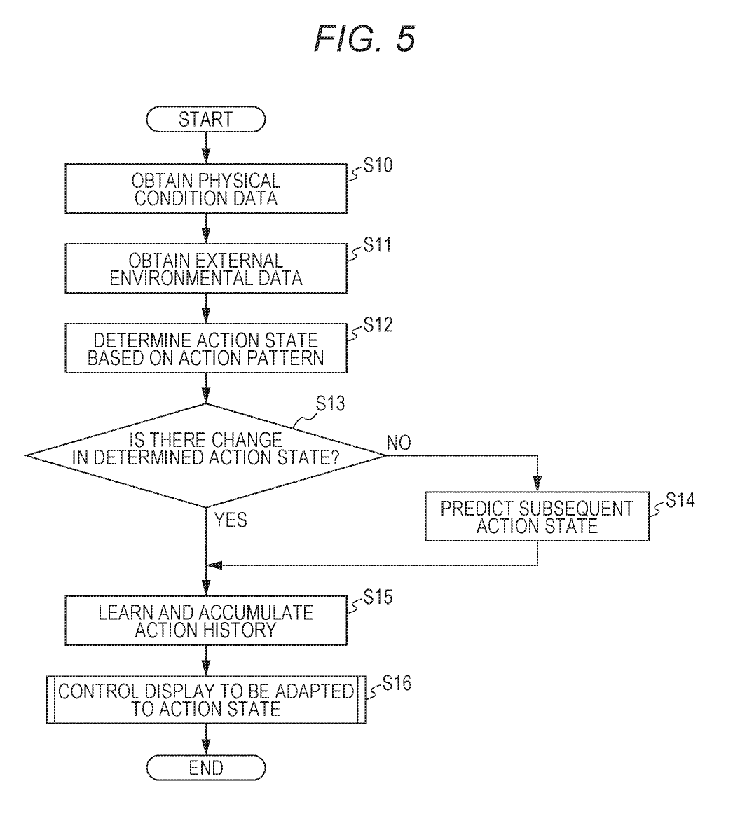

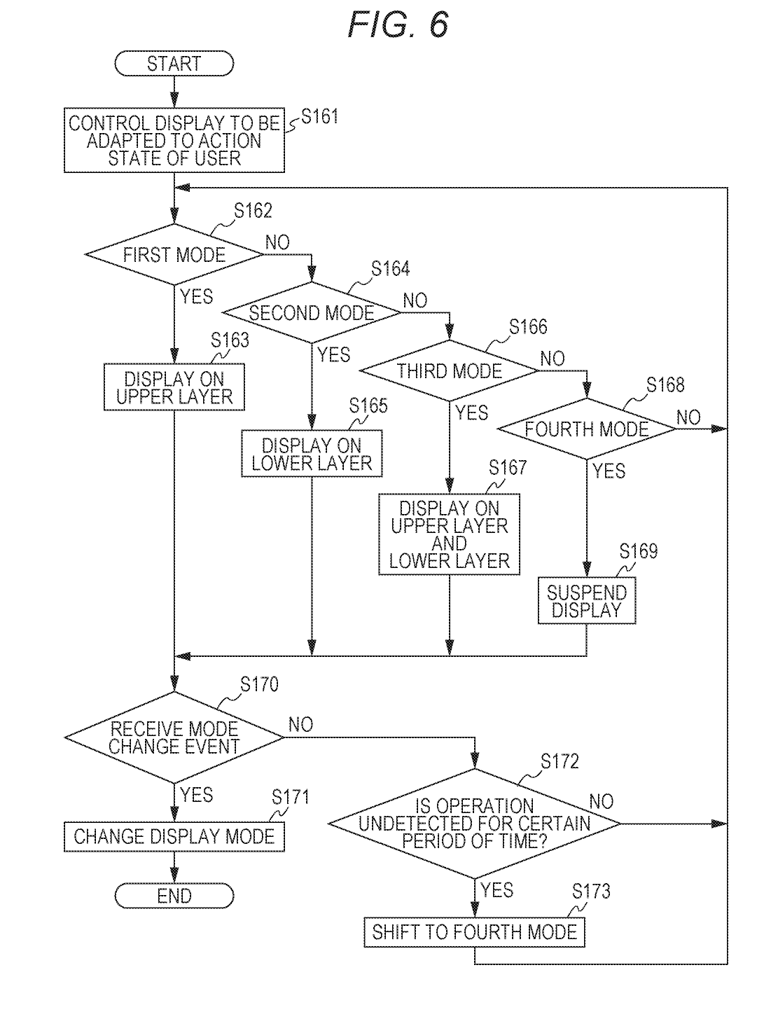

Hereinafter, operation (display control method) of the portable electronic device 10 according to the first embodiment of the present invention illustrated in FIGS. 1 to 4 will be described in detail with reference to flowcharts of FIGS. 5 and 6. It is possible to realize each step described below by causing a computer to execute a corresponding program.

The flowchart of the basic operation of the portable electronic device 10 according to the first embodiment of the present invention is illustrated in FIG. 5. According to FIG. 5, in the portable electronic device 10 according to the first embodiment of the present invention, the biological sensor 111 of the sensor unit 11 detects physical condition data (biological information) of the user, which are then obtained by the control unit 13 and delivered to the display control unit 130 (step S10). Next, the environmental sensor 112 detects external environmental data (environmental information), which are then obtained by the control unit 13 and delivered to the display control unit 130 (step S11). At this time, the display control unit 130 also obtains other data such as GPS data detected by the environmental sensor 112. The biological information and the environmental information are measured and obtained in any order, and obtained according to order of being detected by the respective sensors.

In response to these steps, the display control unit 130 of the control unit 13 determines the action state of the user based on the action pattern determination table 122a stored in the action storage unit 122 (step S12). Before determining the action state, the display control unit 130 generates, for example, data regarding the motion state and the external environment indicated in the input data tables 121a, 121b illustrated in FIGS. 3A and 3B based on the biological information and the environmental information obtained by the sensor unit 11. The display control unit 130 then searches, for example, the action pattern determination table 122a illustrated in FIG. 4A based on the motion state information and the external environment information set in the input data tables. In a case where, for example, the motion state set in the input data table 121a is “walking”, and the external environment set in the input data table 121b is “on road”, the display control unit 130 determines that the action state of the user is “walking”.

When a certain change is recognized in the motion state information and/or the external environment information set in either of the input data tables 121a, 121b (step S13 “YES”), the display control unit 130 activates the prediction unit 132 and causes the prediction unit 132 to execute a process of predicting the next action state subsequent to the action state determined by the display control unit 130. The prediction unit 132 executes the prediction of the action state of the user by, for example, searching the action pattern prediction table 122b illustrated in FIG. 4B. In other words, in a case where both of the action patterns before and after the prediction are “running”, the prediction unit 132 predicts “running” In a case where the action patterns before and after the prediction are “running” and “trail running”, the prediction unit 132 predicts “trail running” (step S14).

Next, the display control unit 130 activates the learning unit 131 and causes the learning unit 131 to execute a process of learning the action state. The learning unit 131 performs control so as to cause the learning result to be reflected in the typically classified action pattern stored in the action pattern determination table 122a, and store such an action pattern as the action history of the user. In other words, the action history is sequentially updated in accordance with the action of the user, and the action state is estimated based on the learning with reference to the updated action history (step S15).

Next, the display control unit 130 controls the “first display state” and the “second display state” of the display unit 14 such that the display state is adapted to the action state determined by the display control unit 130 itself or the subsequent action state predicted by the prediction unit 132 (step S16). As mentioned above, the display unit 14 is configured to be capable of displaying the “first display state” having a low power consumption and a low-definition display content and the “second display state” having a high power consumption and a high-definition display content relatively with respect to each other.

A detailed procedure for “controlling the display unit to be adapted to the action state” in step S16 of FIG. 5 is illustrated in FIG. 6. The display control unit 130 obtains the determined or predicted action state of the user and determines the display mode to be adapted to the action state (step S161). Hereinafter, the procedure will be described in detail with reference to the hardware configuration of FIG. 2. In a case where the “first mode” is set (step S162 “YES”), the low-powered first processor 141 drives the driver 144 to display the display data drawn in the memory 143 on the upper-layer display 148 (step S163).

In a case where the “second mode” is set (step S164 “YES”), the high-performance second processor 142 drives the driver 146 to display the display data drawn in the memory 145 on the lower-layer display 149 (step S165). In a case where the “third mode” is set (step S166 “YES”), the low-powered first processor 141 drives the driver 144 to display the display data drawn in the memory 143 on the upper-layer display 148, and the high-performance second processor 142 drives the driver 146 to display the display data drawn in the memory 145 on the lower-layer display 149. In other words, the first processor 141 and the second processor 142 operate in the dual configuration, and each of the first processor 141 and the second processor 142 combines and displays the display data drawn in the memories 143, 145 (step S167).

When executing the “third mode”, the first processor 141 and the second processor 142 need to operate in cooperation with each other to share information such that the “first display state” and the “second display state” are displayed in synchronization with each other. At this time, the upper-layer display 148 and the lower-layer display 149 can be displayed at the same time to be displayed to overlap each other. In this case, the first processor 141 and the second processor 142 need to cooperate with each other to provide the synchronized displays in consideration of the appearance.

On the other hand, in a case where the “fourth mode” is set (step S168 “YES”), both of the first processor 141 and the second processor 142 stop driving the drivers 144, 146. As a result, both of the upper-layer display 148 and the lower-layer display 149 suspend the display operation (step S169).

When the display control unit 130 executes the display control adapted to the action state of the user in a case where, for example, a wearable device is used, the display control unit 130 does not need to always provide the colorful high-definition second display state of the lower-layer display 149. Alternatively, the display control unit 130 only needs to drive the upper-layer display 148 so that the first display state having an extremely low power consumption is provided at all times, and to switch the display state to the second display state only during a period of time when the user is looking at the screen of the display unit 14. Accordingly, the low-powered first processor 141 always monitors whether a mode change event arrives (step S170). The mode change event as used herein is a trigger for causing the first processor 141 to recognize that the user is looking at the display unit 14. Examples of the mode change event include “button depression”, “touch by the user on the touch panel”, “automatically detected posture of the user”, “detected specific gesture and specific shock”, and “voice command” or the like.

The first processor 141 receives the above-mentioned mode change event detected by the biological sensor 111, the environmental sensor 112, and the imaging sensor 113 or the like (step S170 “YES”) to change the display mode. For example, the first processor 141 changes the setting from the “second mode” or the “third mode” to the “first mode” (step S171). In a case where the operation for the touch panel unit 15 or the like has not been detected for a predetermined period of time or more in the “second mode” and the “third mode” (step S172 “YES”), the first processor 141 also performs control so as to shift the setting to the “fourth mode” (step S173).

When executing the display control using the above-mentioned modes, the first processor 141 and the second processor 142 operate in cooperation with each other to share information such that the “first display state” and the “second display state” are displayed in synchronization with each other in the “third mode”. In addition, the upper-layer display 148 and the lower-layer display 149 can be displayed at the same time to be displayed to overlap each other. In this case, the first processor 141 and the second processor 142 need to cooperate with each other to provide the synchronized displays in consideration of the appearance.

(Effect of First Embodiment)

As mentioned above, in the portable electronic device 10 according to the first embodiment of the present invention, the control unit 13 refers to the action storage unit 122 that stores therein the action pattern and also refers to the action history of the user based on the result measured by the sensor unit 11. The control unit 13 then controls the driving of the “first display state” (display state having a low power consumption and a low-definition display content) and the “second display state” (second display state having a high power consumption and a high-definition display content) relatively with respect to each other such that the display state is adapted to the action state of the user. As a result, the operation of the display can be optimally controlled without depending on various types of users or a variety of user actions.

It is also possible to save power while the user is not aware of it. For example, when the data during the exercise are measured by the wearable device, information desired to be displayed or an interval for updating the displayed information differs depending on the type of exercise. For example, while information such as a pace needs to be updated in seconds during the exercises characterized by speed such as the running and the bicycle, the exercises such as climbing a mountain performed at a steady pace only require, in many cases, the update of the display at very long intervals. The former type of exercise places importance on the visibility when the user glances at the display, and such visibility may be realized by, for example, the display with simple large-sized numbers. The latter type of exercise places importance on comprehensive understanding of the condition which may be realized by, for example, the display with a current position derived from a map. In other words, different ways of displaying information are required.

Operating the unnecessary display unit 14 or operating the display unit 14 more frequently than necessary without distinguishing between these types of exercises leads to rapid exhaustion of a battery for the wearable device. In the portable electronic device 10 according to the first embodiment, however, the control unit 13 can estimate the type of the action performed by the user to realize the optimal display control adapted to the situation either automatically or with a very few operation steps performed by the user. As a result, it is possible to suppress unnecessary exhaustion of the battery, and deliver the information currently required by the user via the display adapted to the situation. In addition, the user can also modify the controlled state to a state that matches his/her preferences. Once the modified state is learnt, the next and subsequent controlling processes can be started in the state desired by the user.

When the control unit 13 recognizes that the user is approaching an area which the user has once been to, the control unit 13 can refer to the accumulated action history of the user to control the display in the same way. In this case, since the control unit 13 (display control unit 130) only needs to refer to the action history of the user and the process of determining the action state is no longer required, entire throughput is improved. For example, in a case where there is a log obtained when the user previously went on a hike near Mount X, and the user is now moving on foot in Mount X again, the control unit 13 determines to perform the same measurement for the hiking, thereby capable of selecting and operating only the necessary display in the same way as the last time. In addition, for example, it is also possible to perform control so as to display a dialog for temporarily stopping the display when the user is determined to have been in a stationary state for n minutes, and restart the operation, after the temporary stop, once the user starts walking.

The above-mentioned description of the portable electronic device 10 according to the first embodiment of the present invention has only referred to the example where the display control unit 130 controls the driving of the “first display state” and the “second display state” by switching the mode to be adapted to the action state of the user. However, the display control unit 130 may control the display operation such that the display operation is adapted to the action state of the user in accordance with the contents of a display control table (not illustrated) preliminarily and differently stored in a predetermined area of the storage unit 12. For example, in a case where the motion state information and the external environment information are estimated by the input data table 121 to be “Mount X area, walk in a place except for a road”, the action state is determined to be hiking by the action storage unit 122. At this time, a preset operation for the display adapted to the hiking is started according to preset data defined in the display control table. The preset data define, in addition to the above-mentioned modes, data required for the display for the respective action types, and intervals for updating the display. If the preset data stored in the display control table do not match those desired by the user, the user can manually modify and change the preset data.

The above-mentioned portable electronic device 10 according to the first embodiment of the present invention is a stand-alone configuration including the action storage unit 122 placed within the device, and the control unit 13 controls, with reference to the action history stored in the action storage unit 122, the operation state of the display unit 14 such that the operation state is adapted to the action state of the user. However, the operation of the portable electronic device 10 is not limited to this operation.

The action storage unit 122 within the portable electronic device 10 can function as a memory that receives the action state stored in an external server (not illustrated) via the communication unit 16 to temporarily preserve the received action state. Consequently, it is possible to refer to a large number of action patterns and action histories of a large number of users.

Furthermore, the portable electronic device 10 can make an inquiry to the server through the communication unit 16 via a network, and the server can automatically control the operation state of the display unit held by the terminal such that the operation state is adapted to the action state of the user.

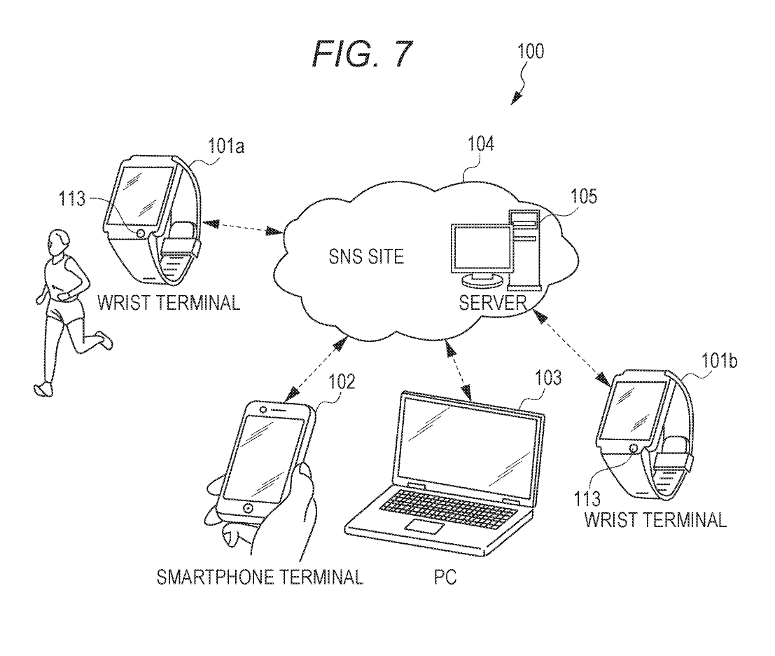

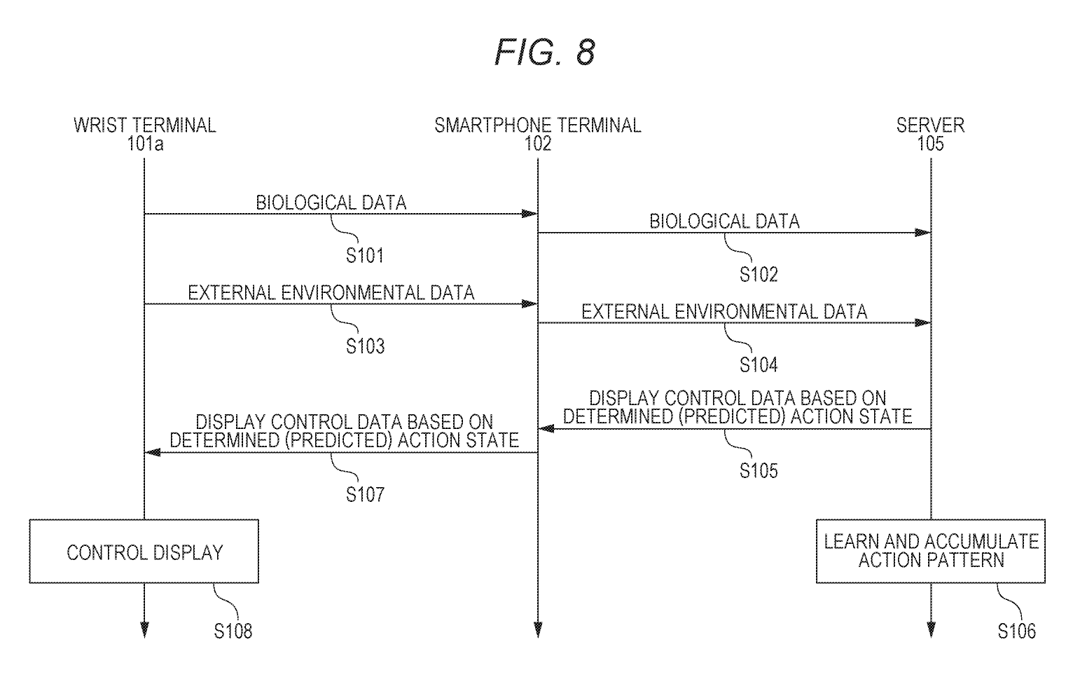

Hereinafter, a display control system using a network will be described as a second embodiment with reference to FIGS. 7 and 8.

(Configuration of Second Embodiment)

A configuration of the display control system 100 according to the second embodiment of the present invention is illustrated in FIG. 7. In the following description, a smartphone is referred to as smartphone terminal, a personal computer is abbreviated as PC, and a social network service system is abbreviated as SNS.

An SNS site 104 including a server 105 is coupled, via the Internet, to a smartphone terminal 102, wrist terminals 101a, 101b, and a PC 103, each owned by a member. The wrist terminals 101a, 101b as used herein each refer to a wristwatch terminal that can be worn on an arm and wirelessly connected to the smartphone terminal 102. The wrist terminal 101a has a main body including the biological sensor and the environmental sensor including the GPS receiver or the like illustrated in FIG. 1 as the sensor unit 11. The main body also includes the display unit and the control unit that controls these sensors. The main body is a wearable main body capable of being worn by the user. In the example illustrated in FIG. 7, the imaging sensor 113 such as the CMOS and the CCD is provided as a part of the sensor unit 11.

The smartphone terminal 102 functions as a communication terminal. An application program is installed on the smartphone terminal 102 so that the smartphone terminal 102 operates in cooperation with the SNS site 104. Relatively light application programs are installed on the wrist terminals 101a, 101b as well so that the wrist terminals 101a, 101b operate in cooperation with the smartphone terminal 102. In other words, the smartphone terminal 102 mediates between the wrist terminals 101a, 101b and the SNS site 104 and can be replaced with a small PC, a tablet, a wireless router or the like. Another route is also available in which the wrist terminals 101a, 101b are directly connected to the server 105 so that information can be exchanged using Wi-Fi (registered trademark) or a telephone line without passing through the smartphone terminal 102.

The server 105 includes the action storage unit that stores therein the action pattern, the exemplary data structure of which is illustrated in FIGS. 4A and 4B. The server 105 sends, to the control unit of the portable electronic device such as the wrist terminals 101a, 101b and with reference to the action storage unit, a control signal for controlling the operation states of the display units of the wrist terminals 101a, 101b such that the operation states are adapted to the action state of the user. The control unit then controls, based on the control signal, the operation state of the display unit such that the operation state is adapted to the action state of the user. The server 105 further includes the input data table, the exemplary control data of which are illustrated in FIGS. 3A and 3B.

(Operation of Second Embodiment)

Hereinafter, operation (display control method) of the display control system 100 according to the second embodiment of the present invention will be described in detail with reference to an operation sequence diagram of FIG. 8. It is possible to realize each step described below by causing a computer to execute a corresponding program. First, according to FIG. 8, the wrist terminal 101a sends the biological information detected by the biological sensor to the server 105 via the smartphone terminal 102 (step S101, S102). Next, the wrist terminal 101a sends the environmental information and other data detected by the environmental sensor including the GPS receiver to the server 105 via the smartphone terminal 102 (step S103, S104). The biological information and the environmental information are obtained by the server 105 in any order, and obtained according to order of being detected by the respective sensors.

The server 105 which has obtained the biological information and the environmental information or the like from the wrist terminal 101a searches the built-in action storage unit, generates the display control data including the display mode based on the determined or predicted action state of the user, and sends the display control data to the wrist terminals 101a, 101b via the smartphone terminal 102 (step S105, S107). The server 105 simultaneously learns the action state of the user and accumulates the result in a built-in memory to use the result for determining or predicting the next and subsequent action states of the user (step S106). The wrist terminals 101a, 101b which have received the display control data control the display units according to the display control data (step S108). In other words, the wrist terminals 101a, 101b control, in accordance with the display control data including the display mode obtained by the server, the driving of the “first display state” (display state having a low power consumption and a low-definition display content) and the “second display state” (second display state having a high power consumption and a high-definition display content) relatively with respect to each other such that the display state is adapted to the action state of the user.

(Effect of Second Embodiment)

As mentioned above, the display control system 100 according to the second embodiment of the present invention is configured in such a manner that the wrist terminals 101a, 101b make inquiries for the display control data to the server 105 based on the detected biological information and environmental information or the like, and the server 105 controls, with reference to the built-in action storage unit, the operation states of the displays of the wrist terminals 101a, 101b such that the operation states are adapted to the action state of the user. As a result, the display units held by the wrist terminals 101a, 101b can be automatically controlled so that the display mode, the operation timing, the type, or the interval for updating the display are optimally selected. Therefore, the operation of the display of the terminal can be optimally controlled without depending on various types of users or a variety of user actions. At this time, it is possible to switch the display mode in response to receiving the mode change event, and it is also possible to stop the needless display operation in response to detecting absence of the operation for a certain period of time. Accordingly, unnecessary consumption of batteries for the wrist terminals 101a, 101b can be suppressed and failure or the like in the measurement due to an operating error of the user can also be avoided.

In the same way as the portable electronic device 10 according to the first embodiment, the display control system 100 according to the second embodiment also allows the user to modify the tables or the like stored in the action storage unit 122 and used for the determination according to his/her preferences. Once the modified tables or the like are learnt, the next and subsequent controlling processes for the display can be controlled at a timing desired by the user. Since the determination is mainly performed by the server 105, the action pattern determination table stored in the action storage unit can be updated precisely and finely without the need for frequently rewriting firmware in the main bodies of the wrist terminals 101a, 101b.

The present invention has been described so far with reference to each embodiment. Needless to say, however, the technical scope of the present invention is not limited to the scope described in the above-mentioned embodiments. It is obvious to a person skilled in the art that various changes or modifications can be applied to the above-mentioned embodiments and examples. It is also obvious from the description of the scope of the claims that such changed or modified embodiments can also be included in the technical scope of the present invention.

### APPENDIX

1. An electronic device comprising:
a display unit;
an action storage memory configured to store therein an action history of a user; and
a control unit configured to control the display unit, wherein
the display unit is configured to be capable of displaying a first display state and a second display state having a higher power consumption than the first display state, and
the control unit controls, based on the action history of the user, the first display state and the second display state such that the display state is adapted to an action state of the user.

2. The electronic device according to claim 1, wherein
the action state comprises a first action state currently in progress.

3. The electronic device according to claim 1, wherein
the action state comprises a second action state predicted to be a subsequent action state.

4. The electronic device according to claim 1, wherein
the action storage memory preliminarily stores therein a typically classified action history.

5. The electronic device according to claim 1, comprising a sensor configured to measure a condition of the user and/or an environment where the user is located, wherein
the action storage memory stores therein the action history of the user based on a result measured by the sensor.

6. The electronic device according to claim 1, wherein
the action storage memory receives and stores therein at least a part of an action history stored in an external server.

7. The electronic device according to claim 1, wherein
the display unit comprises a multi-layer display, and
a display control unit displays the first display state on a first display and the second display state on a second display, and causes the display state to switch between the first display state and the second display state.

8. The electronic device according to claim 7, wherein
the first display is a polymer network (PN) liquid crystal, and
the second display is a thin film transistor (TFT) liquid crystal.

9. The electronic device according to claim 1, wherein
the display control unit has:
a first mode that displays only the first display state;
a second mode that displays only the second display state;
a third mode that combines and displays both of the first display state and the second display state; and
a fourth mode that suspends both of the first display state and the second display state.

10. The electronic device according to claim 9, wherein
the display control unit shifts the display unit to the fourth mode when operation has not been detected for a predetermined period of time or more in the second mode and the third mode.

11. The electronic device according to claim 9, wherein
the display control unit has a first processor having a low power consumption and configured to control the first display state, and a second processor having high performance and configured to control the second display state.

12. The electronic device according to claim 11, wherein
the display control unit causes the first processor and the second processor, each being independent of the other, to operate in cooperation with each other to share information such that, in the third mode, the first display state and the second display state are displayed in synchronization with each other.

13. The electronic device according to claim 1, wherein
the action history is sequentially updated in accordance with an action of the user, and
the action state is predicted based on learning based on the updated action history.

14. The electronic device according to claim 1, further comprising a main body including the display unit, the action storage memory, and the control unit, wherein
the main body is a wearable main body capable of being worn by the user.

15. A display control system comprising:
an electronic device; and
a server coupled to the electronic device via a network, wherein
the electronic device includes:
a display unit configured to be capable of displaying a first display state and a second display state having a higher power consumption than the first display state relatively with respect to each other; and
a control unit configured to control, based on an action history of a user, driving of the first display state and the second display state such that the display state is adapted to an action state of the user.

16. The display control system according to claim 15, wherein
the server sends, to the control unit of the electronic device and based on an action history stored in an action storage memory of the server, a control signal for controlling the driving of the first display state and the second display state such that the display state is adapted to the action state of the user, and
the control unit controls, based on the control signal, the driving of the first display state and the second display state such that the display state is adapted to the action state of the user.

17. A display control method comprising the steps of, by a computer of an electronic device:
storing an action history of a user; and
controlling, in accordance with the action history, driving of a first display state and a second display state having a higher power consumption than the first display state relatively with respect to each other such that the display state is adapted to an action state of the user.
